(19) United States
(12) Patent Application Publication
(10) Pub. No.: US 2016/0111915 A1
(43) Pub. Date: Apr. 21, 2016

(54) INSTALLATION FOR RESTORING POWER TO EQUIPMENT TO BE SUPPLIED WITH POWER, PARTICULARLY AN ELECTRIC VEHICLE

(71) Applicant: BLUE SOLUTIONS, Ergue Gaberic (FR)

(72) Inventors: Christian Sellin, Concarneau (FR); Jacques Colin, Quimpler (FR); Yvon Le Paven, Ergue Gaberic (FR); Alain Vallee, Varennes (CA); Valery Florimond, Montreal (CA); Karim Sammouda, Chambly (CA); Jean Caron, Saint Eugene De Grantham (CA); Pierre-Luc Etienne, Saint-Constant (CA)

(21) Appl. No.: 14/892,988

(22) PCT Filed: May 21, 2014
(86) PCT No.: PCT/EP2014/060404

§ 371 Date: Nov. 20, 2015

(30) Foreign Application Priority Data
May 22, 2013 (FR) 1354583

(51) Int. Cl. H02J 9/06; B60L 11/18; H02M 7/44; H02J 3/38; H02M 3/04

(52) U.S. Cl. CPC H02J 9/061; H02J 3/383; H02M 3/04; H02M 7/44; B60L 11/1809

(57) ABSTRACT

The invention relates to an installation (10) for restoring power to equipment, comprising at least one photovoltaic cell (20A-20D; 22A-22B), at least one device for supplying power (12) comprising electrical connection means (14), at least one power storage assembly (18A, 18B), connected on the one hand to at least one of the photovoltaic cells and on the other hand to at least one of the power supply devices to supply it with electrical power, and an inverter (28, 30) interposed between at least one of the power storage assemblies and at least one of the power supply devices, so that the electricity transmitted to the supply device is in the form of alternating current. The invention also relates to a charging module comprising at least one power storage assembly and at least one inverter.

The present invention relates to a station for restoring power to electrical equipment, allowing charging of this equipment, particularly an electric vehicle such as an automobile or an autobus, or a lighting device.

Such stations, which comprise photovoltaic panels connected to a buffer storage battery, are known in the state of the art, the power of the buffer battery then being distributed to the vehicle through a charging terminal comprising electrical connection means cooperating with complementary means of the vehicle and connected to the buffer battery. Conventionally, the power is transmitted as direct current from the solar panels to the buffer battery of the charging station and also as direct current from the buffer battery of the charging station to a battery of the vehicle, because the current is generated in that form by the solar panels, and also stored in that form by the power storage buffer batteries.

In certain installations by which it is desired to charge a great number of vehicles, it can be necessary to also use the urban electric grid to recharge vehicles, as a supplement to or replacement of the solar panels. The electrical power in such a network exists as alternating current.

To optimize costs, however, it is preferable to standardize the installations as much as possible so as to be able to charge a vehicle in the same manner whatever the environment and the means by which the electrical power is obtained.

To this end, the invention has as its object an installation for restoring power to equipment to be supplied with power, the installation comprising:
at least one photovoltaic cell, forming an electric power source,
at least one device for supplying power comprising electrical connection means,
at least one power storage assembly, connected on the one hand to the or at least one of the photovoltaic cells to store the electrical power coming from said cell(s), and on the other hand to the or at least one of the power supply devices to supply it with electrical power,
an inverter that converts direct current into alternating current, interposed between the or at least one of the power storage assemblies and the or at least one of the power supply devices, so that the electricity transmitted to the supplying device is in the form of alternating current.

Thus, the electrical power obtained from the photovoltaic cell is transferred to a power storage assembly in direct form, but the combined assembly formed by the battery and the inverter transmits the electricity to the power supply device in alternating form.

The power supply device is then supplied with alternating current, whether it is supplied through the urban electrical grid or through photovoltaic panels.

Such a power supply device is therefore standard, and of simple design because it interacts with the vehicle in the same manner, no matter what the environment in which it is placed (with output from the urban grid or from photovoltaic cells). The device and the equipment to be supplied with which it is connected (particularly vehicles) can therefore be standardized, the installation being modified upstream of the supply device if this is connected with photovoltaic cells. An electric power supply installation can thus be created more easily with standard elements, even when needs and conditions vary. Moreover, maintenance of the installation is also facilitated due to standardization of the supply device.

It will be noted that the presence of the power storage assembly(ies) makes it possible to store power acquired by the photovoltaic cells when insolation allows it, and to restore it when that is required.

A person skilled in the art would not have been stimulated to move toward this solution, which generates a reduction in efficiency of the installation due to the dual conversion of the current type that is necessary. However, the cost of losses due to this loss of efficiency is compensated by the cost savings due to standardization, particularly of the supply devices.

The installation can also comprise one or more of the features from the following list:
the supply device is a charging terminal for a vehicle, comprising electrical connection means capable of being connected to complementary means of the vehicle,
it comprises at least one direct current converter (DC/DC) between at least one photovoltaic cell and the or one of the buffer power storage assemblies provided in the installation, to adapt the power obtained from the cell(s) to that which allows optimal operation of the batteries. The installation can comprise a plurality of converters positioned in parallel and connected to one and the same power storage assembly, each converter being connected to (a) distinct photovoltaic cell(s),
the or at least one of the buffer power storage assemblies comprises a module for communicating with control means of the or at least one of the converters, to communicate an instruction relating to the electrical power received, particularly an instruction related to voltage or current (“current or voltage setpoint”), the control means controlling said converter depending on the instructions received,
the installation preferably comprises means of measuring the amount of power delivered by the or at least one of the converters, the control means of the converter(s) controlling the converter depending on the results obtained by the measurement means. Efficiency of the solar panels and of the power storage is thus optimized. Preferably, the control means control the converter depending on the results of the measurement means when the control means cannot apply the instructions received from the corresponding storage assembly,
the installation preferably comprises several photovoltaic panels arranged in parallel and connected to one and the same converter,
the supply device comprises an AC/DC converter capable of transforming the input electrical power received in the form of alternating current into output electrical power in the form of direct current. The power is in fact generally stored in the form of direct current in electric vehicles. This converter is, however, optional, the vehicle charger being able to carry out on its own this conversion function, particularly through its charger,
the installation is connected to an urban electrical grid, the urban electrical grid being connected to the installation in parallel with the output of the inverter. In this manner, the urban electrical grid can be brought to the input of the supply device, this device being able to receive electrical power coming from two sources: the urban electrical grid or the photovoltaic cells. Whatever the power source, the electrical power will arrive in the same form at the device, which need not be made more complex to adapt to different forms of electrical power (alternating or continuous current),
several power storage assemblies are arranged in parallel in the installation, and connected to one and the same supply device,
the installation comprises means for interrupting the electric circuit controlled by the supply device, and particularly the connection means for said device.
These interruption means are positioned between the electrical source and the connection means, particularly between the or at least one of the power storage assemblies and the supply device. In the case where the supply device is supplied by several power sources, the interruption means are partially or totally distinct for each power source. The interruption means can for instance comprise a switch at the output of each of the power storage assemblies,
   the installation comprises means for communicating with the vehicle through the supply device and the power supplied to the vehicle depends on the data received through the communication means. The data can in particular give an overview of the charge level of the vehicle battery. The interruption means can also be controlled in this way. In this manner, if the vehicle is charged, the connection between the supply device and the buffer storage assemblies provided in the installation is cut off,
   the or each power storage assembly is a battery comprising an anode and a cathode, particularly a lithium-metal-polymer (LMP) battery provided with a solid electrolyte.

The invention also has as its object a recharging module designed to be placed in a recharging installation, and designed to be connected, on the one hand, to at least one photovoltaic cell, and on the other hand to at least one device for supplying power to equipment to be supplied (such as a vehicle) comprising means for connecting to said equipment to be supplied, the recharging module comprising:
at least one power storage assembly designed to be connected, on the one hand, to one or more photovoltaic cells, to store the power coming from the photovoltaic cells, and on the other hand to the supply device(s), to supply electrical power to it or them,
at least one inverter connected in series with the or at least one of the storage assemblies so as to be interposed between this storage assembly and the or one of the power supply devices.

The module also preferably comprises at least one direct current converter, connected in series with the or at least one of the power storage assemblies, so as to be interposed between that storage assembly and at least one photovoltaic cell or several photovoltaic cells in parallel. The module can also comprise other elements of the system, in particular all the intermediate elements of the installation situated between the photovoltaic cell(s) and the supply device(s).

The module is a container comprising a location for a plurality of storage assemblies, inverters, etc. It can also be connected directly to the power supply devices as well as to photovoltaic cells through a single connection and it makes it possible to ensure good operation of the installation without however increasing the connection hardware exposed to the outside. A good lifetime of the installation is thereby guaranteed because the connection hardware and the different constitutive elements of the module are protected against bad weather, as well as better esthetics of the installation (placed on the public highway) and facilitated maintenance. This module also makes it possible to adapt itself to different types (sizes, nature, etc.) of installation.

The container can also of course be connected to the urban grid.

It will be noted that the container is equipped with a plurality of air inlets for cooling the different elements constituting the module. This makes it possible to place numerous elements constituting the installation (supplied with high voltage and which therefore have a tendency to heat up from the Joule effect) in an enclosed and limited space, without producing heating which could lead to fires. The container can also moreover be equipped with a heat and/or fire detector to improve the safety of the installation.

An embodiment of the invention constituting a non-limiting example thereof will now be described in detail, using the appended figures wherein:

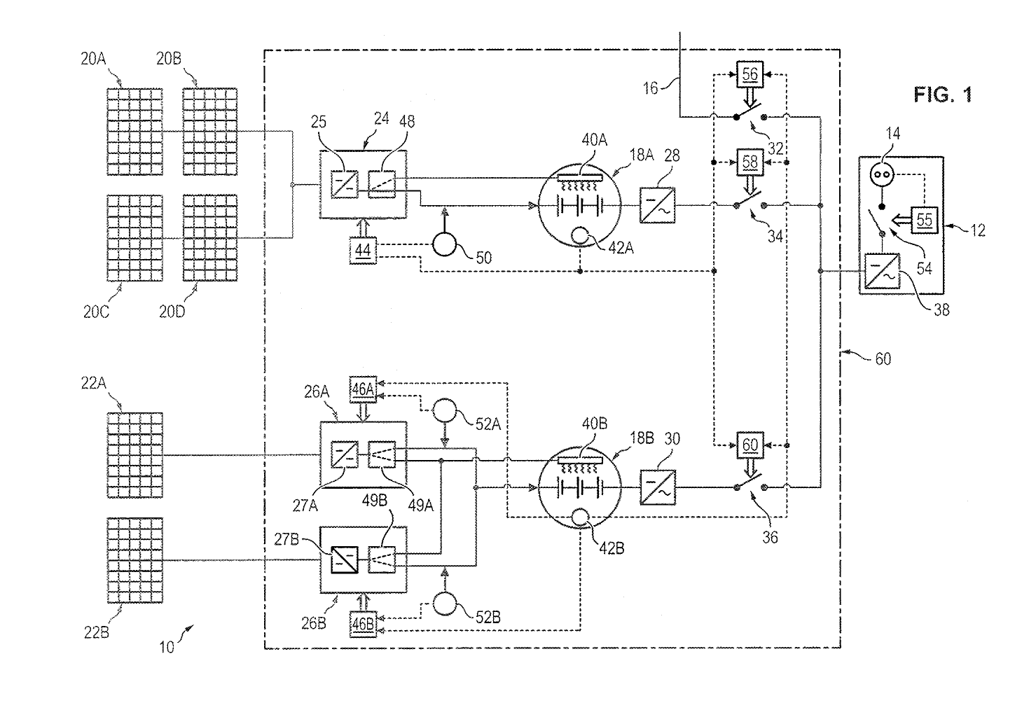

FIG. 1 is a simplified electrical schematic of an electrical recharging installation according to a particular embodiment of the invention,

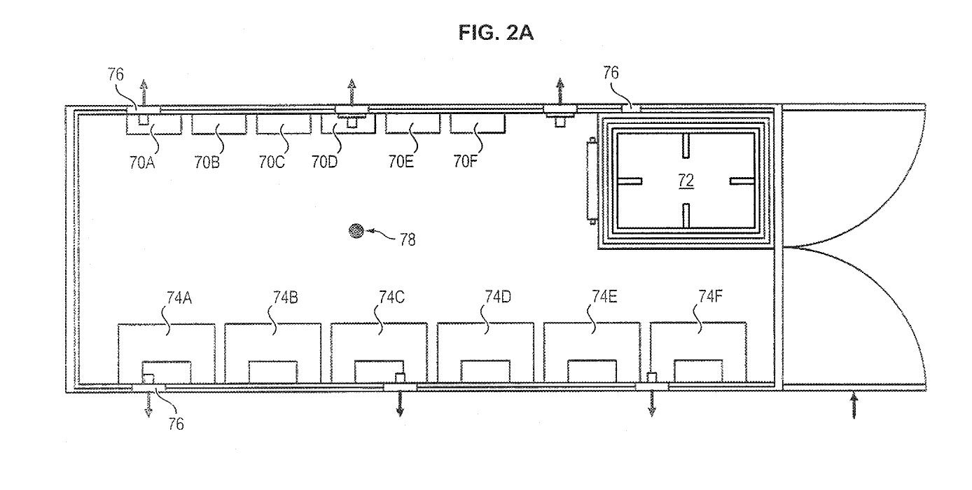

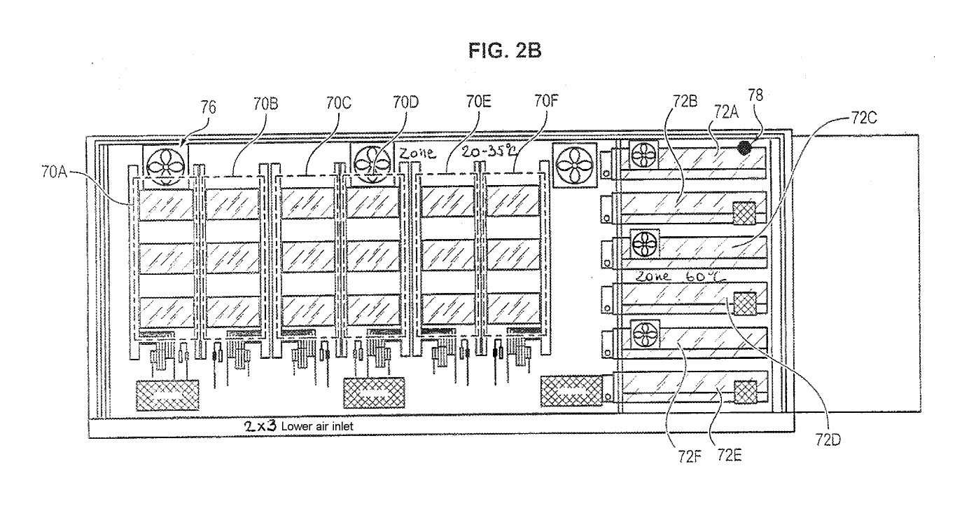

FIGS. 2A and 2B are respectively top and side section views of a recharging module according to a variant embodiment of the invention.

As can be seen in FIG. 1, the installation 10 is an installation designed to recharge an electric vehicle, such as for example an automobile or an autobus, using an electric power supplying device 12, also called hereafter a “charging terminal.” This charging terminal 12 is placed on the public highway and comprises electrical connection mean designed to be connected as needed to complementary connection means of the vehicles to be charged. The aim of this description is not to describe the architecture of the terminal. One can, however, specify that the connection means are located outside the terminal and that they are preferably accessible to selected persons, particularly only to authorized persons, for example by means of a cover with limited access locking means.

The supply device 12 is connected, on the one hand, to the urban electrical grid 16 and on the other hand to two power storage assemblies 18A, 18B positioned mutually in parallel and in parallel with the urban grid 16, these power storage assemblies 18A, 18B allowing electrical power coming from electrical power sources, here photovoltaic panels respectively 20A-20D, connected to the power storage assembly 18A, and 22A, 22B connected to the storage assembly 18B, to be stored. Each photovoltaic panel generally comprises a plurality of photovoltaic cells, which make it possible to transform photons of light received into electrical power.

It will be noted that the power storage assemblies 18A, 18B described in this embodiment also comprise in particular electrical storage batteries comprising a plurality of elementary cells (comprising an anode and a cathode), particularly lithium-metal-polymer (LMP) batteries having an electrolyte in solid form. Other types of storage assemblies could however be used, such as lithium-ion batteries for example. These different types of storage assemblies store the electrical power in the form of direct current.

A charger 24 is interposed between the photovoltaic panels 20A-20D and the power storage assembly 18A. The panels 20A and 20B, as well as the panels 20C and 20D respectively, are connected in series, and the two branches comprising the panels 20A, 20B and 20C, 20D are connected in parallel. Two chargers 26A, 26B are also interposed respectively between each photovoltaic panel 22A, 22B and the power storage assembly 18B, the chargers 26A, 26B being connected in parallel at the input of the power storage assembly 18B.

It will be noted, however, that other combinations of connections between the photovoltaic panels and the charger(s) and between the charger(s) and each battery are possible. The number and the arrangement of the panels connected to one and the same charger can in fact vary, as well as the number of chargers connected in parallel at the input of each battery. It is however recommended to adapt the number and the disposition of the panels at the input of each charger depending on the power and the voltage that the charger can manage, so as to optimize the operation and the costs of the installation.

Each charger 24, 26A, 26B comprises a DC/DC converter 25, respectively 27A, 27B, which makes it possible to convert the current and particularly to supply optimum power from the signal coming from the photovoltaic cells, this depending on the needs of the power storage assembly.

An inverter 28, respectively 30 has also been placed at the output of the batteries 18A, 18B. In this manner, each inverter 28, 30 is interposed between the output of the corresponding battery 18A, 18B and the input of the supply device 12. This inverter makes it possible to transform the electrical power stored as direct current in the batteries into electrical power in the form of alternating current.

The urban grid 16 arrives at the input of the charging terminal in parallel with the output of the inverters 28, 30. Thus, the charging terminal 12 can be supplied either by power coming from the solar panels 20A-20D, 22A, 22B and from the power storage assembly 18A, 18B, or from the urban electrical grid 16. No matter what the source of the electrical power, the current arrives in any case in the alternating form, which makes it possible to treat it in the same manner at the charging terminal 12. The charging terminal 12 is therefore a standard charging terminal, which can be the same whatever the type of installation in which it is installed (panel output and/or urban grid).

The installation also comprises means 32, 34, 36 for interrupting the electrical circuit at each branch arriving at the charging terminal 12, the switch 32 being placed at the output of the branch connected to the urban grid 16 and the switches 34 and 36 being placed at the output of the inverters 28 and 30. This makes it possible not to supply power to the charging terminal 12 if this is not necessary, particularly if no equipment to be supplied is connected to this terminal. This also contributes to the safety of the installation.

As the power is generally then stored in the electric vehicle, also in direct current form, the charging terminal 12 also comprises an AC/DC converter 38 interposed between the input and the output of the charging terminal 12. Such a converter, however, is not compulsory, because the conversion can if necessary be carried out in the vehicle. It is also practicable that the supply device have the purpose of supplying equipment that consumes the power and does not store it, and which then operates using alternating current. It is then possible to choose not to equip the charging terminal 12 with such a converter 38.

The interactions between the different elements will now be described in more detail.

The power storage assembly 18A or 18B preferably comprises, as has been indicated, an LMP battery, but also advantageously a device for heating the battery, respectively 40A, 40B, which makes it possible to bring the battery to temperature prior to charging it so as to ensure its optimal operation. This device comprises resistors in particular, which dissipate received current by the Joule effect so as to generate heat.

The storage assembly also comprises a communication module, respectively 42A, 42B, which makes it possible to communicate data relating to the battery to other elements of the installation, particularly control means of the chargers, respectively 44 for the communication modules 42A and 46A, 46B for the communication module 42B. The communication modules 42A, 42B can also communicate with one another.

Each power storage assembly also comprises other integrated means, such as means for measuring different parameters (temperature, charge level, etc.), calculation means for determining the needs, particularly for charging, of each battery and means for balancing the various elementary cells to optimize the operation of each battery. These conventional means will not be described in more detail in the remainder of this application. It will be noted that the data that are transmitted through the communication module are data relating to the measured characteristics of each battery, or to those calculated.

Thus, depending on the data communicated by a communication module to the control means of the associated charger, a current coming from the charger could be directed toward the heating device 40A, 40B (when the temperature of the assembly is not considered sufficient) or directly toward the cells of the battery when it is considered that the assembly is within the optimal range of temperatures. The control means 44 (respectively 46A, 46B) can control, to this end, diversion means 48 (respectively 49A, 49B) for the charger. The characteristics of the power transmitted to the battery (voltage and possibly current) generally conform to the requirements of the battery calculated by the calculation module. To arrive at this result, the control means 44 (respectively 46A, 46B) control the DC/DC converter 25 (respectively 27A, 27B) so as to convert the electrical power received from the panels to the voltage required by the battery.

In the case where the storage assembly 18B is supplied by several chargers 26A, 26B, the requirement from each charger is accomplished at the storage assembly 18B, which makes it possible to optimize the operation of the installation by centralizing voltage instructions.

It will be noted that the charger can also transmit data relating to its operation to the storage assembly through the communication module. The requirements of the storage assembly can be adapted depending on the information obtained in return by the storage assembly.

When the voltage commands required by the storage assembly 18A, 18B cannot be attained (particularly because the electrical power supplied by the photovoltaic panels is not sufficient), the charger 24 can be configured to carry out voltage scanning and to analyze instantaneous power for each voltage. Thus the optimal power that can be obtained from the photovoltaic panel is determined, and it is applied. This is carried out using measurement means at the output of the charger, respectively designated 50 and 52A, 52B. These measurement means transmit information to the control means of the charger which control the converter 25, respectively 27A, 27B, so that the converter applies the necessary voltage so that the optimum power is attained.

The operation by which the optimum power is obtained is generally called the MPPT mode (acronym of Maximum Power Point Tracking). This operation has as its objective to search for the maximum power point of the generator formed by the photovoltaic cells, due to the fact that these are nonlinear, meaning that for the same insolation the power delivered by these cells is different depending on the load.

A non-limiting operating mode for such an MPPT operation consists of:
measuring the power P1 delivered by the cells for a fixed output voltage U1,
after a certain time, imposing a second voltage U2 slightly higher than U1, and measuring the corresponding power P2, and
if P2 is greater than P1, attempt to impose an even higher voltage (respectively weaker if P2 is smaller than P1).

Thus the system constantly adapts the voltage at the terminals of the photovoltaic cells 20A-20D, 22A and 22B so as to approach the maximum power point. And if necessary, the converters 25, 27A and 27 then adapt their output voltage depending on the optimal operating point of the buffer batteries 18A and 18B.

When several chargers in parallel are supplying the same battery, only one of the chargers at a time can be placed in MPPT mode. The value of grouped control of the chargers from the storage assembly is therefore real.

These chargers thus make it possible to optimize the charge in each battery. Once the battery is partially or fully charged, it is capable of delivering current to the charging terminal 12 through the inverter 28, 30. As indicated above, however, it is not desirable that current is delivered when the charging terminal 12 is not connected to any equipment to be supplied, such as a vehicle.

To this end, the charging terminal 12 comprises means of detection of the connection of a vehicle to the connection means 14, for example through a pilot wire. The pilot wire also allows the vehicle to communicate with the charging terminal. The charging terminal 12 also comprises an interruption means 54 controlled by control means 55 which changes the position of the interruption means from an open position (no current circulating toward the connector 14) to a closed position (current circulates toward the connector 14) depending on the presence of the vehicle's connector in that of the terminal 14, signaled by the pilot wire.

The control means 56, 58, 60 of the different switches 32, 34, 36 allowing supplying the input of the charging terminal 12 by the different branches are, for their part, controlled according to the data received from different elements of the system, particularly the communication means 42A, 42B of the storage assemblies. The different switches can be controlled to supply the terminal 12 with electrical power successively in a standardized form determined by the inverter 28, 30 and corresponding to the form in which it is distributed in the urban grid 16. One could also imagine that several switches are activated simultaneously.

As a variant, the charging terminal 12 could communicate directly with the control means 56, 58, 60 of the switches 32, 34, 36.

It will be noted that all the intermediate functional elements of the installation (chargers 24, 26; storage assemblies 18A, 18B; inverter 28; 30 and interruption means 32, 34, 36) are placed in the same single charging module 60.

As can be seen in FIGS. 2A and 2B, this single charging module 60 is installed in a container which contains along its walls the chargers 70A-70F, the batteries 72A-72F as well as the inverters 74A to 74F. In the embodiment shown in FIGS. 2A and 2B, the installation comprises in fact 6 batteries 72A through 72F which supply two terminals 12, three batteries being assigned to each of the terminals. Each battery is supplied by three chargers in parallel and comprises an inverter at the output. The different high power connection hardware for transmitting the electrical power, as well as the communication connection hardware, are thus located inside the container.

This container makes it possible to facilitate maintenance and to maintain a suitable elevated temperature for good operation of the batteries. It will be noted, however, that to guarantee the safety of the installation, the container comprises fans 76 for cooling the container, as well as fire detectors 78 to ensure that the incidence of a possible fire in one of the functional elements is stopped before it reaches other elements of the module.

It will be noted that the same container is adaptable and can contain more functional elements that what has been described above, depending on the needs and the charging terminals present on the public highway. The presence of such a module located in the installation is naturally not compulsory.

The invention as described here is not limited to the examples described using the figures. The variants presented in the text also do not limit the scope of the invention, which can also be implemented in other variants.

1. An installation (10) for restoring power to equipment to be supplied with power, the installation being characterized in that it comprises:
at least one photovoltaic cell (20A-20D; 22A-22B), forming an electrical power source,
at least one power supply device (12) comprising electrical connection means (14),
at least one power storage assembly (18A, 18B; 72A-72F), connected on the one hand to the or at least one of the photovoltaic cells to store the electrical power coming from said cell(s) and on the other hand to the or at least one of the power supply devices to supply it with electrical power,
an inverter (28, 30; 74A-74F) interposed between the or at least one of the power storage assemblies and the or at least one of the power supply devices, so that the electricity transmitted to the supply device is in the form of alternating current.

2. The installation according to the preceding claim, comprising at least one DC/DC converter (24, 26A-26B; 70A-70F) between at least one photovoltaic cell (20A-20D; 22A-22B) and the or one of the power storage assemblies (18A, 18B; 72A-72F).

3. The installation according to the preceding claim, comprising a plurality of converters (26A-26B; 70A-70F) arranged in parallel and connected to one and the same power storage assembly (18B; 72A-72F), each converter being connected to one or distinct photovoltaic cells (22A, 22B).

4. The installation according to any one of claim 2 or 3, wherein the or at least one of the power storage assemblies (18A, 18B) comprises a communication module (42A, 42B) with means (44, 46A-46B) for controlling the or at least one of the converters (24, 26A-26B) to communicate an instruction relating to the electrical power received, particularly a voltage instruction, the control means controlling said converter depending on the instructions received.

5. The installation according to any one of claims 2 to 4, comprising means (50, 52A-52B) for measuring the power delivered by the or at least one of the converters (24, 26A-26B), the control means (44, 46A-46B) of the converter(s) controlling the converter depending on the results obtained by the measurement means.

6. The installation according to any one of claims 2 to 5, comprising several photovoltaic panels (22A, 22B) arranged in parallel and connected to one and the same set of converters.

7. The installation according to any one of the preceding claims, wherein the supply device (12) comprises an AC/DC converter (38) capable of transforming the input electrical power received in the form of alternating current into electrical power in the form of direct current.

8. The installation according to any one of the preceding claims, the installation being connected to an urban electrical grid (16), the urban electric grid being connected to the installation in parallel with the output of the inverter (28, 30).

9. The installation according to any one of the preceding claims, wherein several power storage assemblies (18A, 18B; 72A-72C, 72D-72F) are arranged in parallel in the installation, and connected to one and the same supply device (12).

10. The installation according to any one of the preceding claims, comprising means (32, 34, 36) for interrupting the electric circuit controlled by the supply device (12) and particularly the connection means (14) of said device.

11. The installation according to any one of the preceding claims, wherein the or each power storage assembly comprises a battery comprising an anode and a cathode.

12. A recharging module (60) designed to be placed in a recharging installation, and designed to be connected on the one hand to at least one photovoltaic cell (20A-20D; 22A, 22B) and on the other hand to at least one device for supplying electric power (12) to equipment to be supplied, comprising means for connecting (14) to said equipment to be supplied, the recharging module comprising:
at least one power storage assembly (18A, 18B; 72A-72F) designed to be connected, on the one hand, to one or several photovoltaic cells, to store the power coming from the photovoltaic cells, and on the other hand to the supply device(s) to supply it or them with electrical power,
at least one inverter (28, 30; 74A-74F) connected in series with the or at least one of the storage assemblies so as to be interposed between this storage assembly and the or one of the power supply devices.

13. The module according to the preceding claim, comprising at least one DC/DC converter (24, 26A-26B; 70A-70F), connected in series with the or at least one of the power storage assemblies (18A, 18B; 72A-72F), so as to be interposed between this storage assembly and at least one photovoltaic cell (20A-20D; 22A, 22B) or several photovoltaic cells in parallel.

14. The module according to any one of claims 12 and 13, contained in an enclosure formed by a container (62), preferably equipped with a plurality of air inlets (76) for cooling the different elements constituting the module.
